(19) United States
(12) Patent Application Publication
(10) Pub. No.: US 2009/0078377 A1
(43) Pub. Date: Mar. 26, 2009

(54) Weatherstrip for Shutter Device

(76) Inventors: Yasuyuki Ohara, Nagoya-shi (JP); Hajime Takami, Anjo-shi (JP); Ryuji Tanigo, Machida-shi (JP)

Correspondence Address: KENNETH J. LUKACHER, SOUTH WINTON COURT, 3136 WINTON ROAD SOUTH, SUITE 301, ROCHESTER, NY, 14623, US

(21) Appl. No.: 12/226,759

(22) PCT Filed: Jul. 20, 2006
(86) PCT No.: PCT/JP2006/314348

§ 371 Date: Oct. 27, 2008

(30) Foreign Application Priority Data
Apr. 28, 2006 (JP) 2006-126978
May 31, 2006 (JP) 2006-152727

(51) Int. Cl. E06B 9/17

(52) U.S. Cl. 160/127

(57) ABSTRACT

A shutter device includes a pair of support frames spaced in parallel with a predetermined distance therebetween, and a shutter arranged between the support frames. The support frames support both the right and the left shutter flanks of the shutter so as to allow the shutter to reciprocate along a longitudinal direction of the support frames. A weatherstrip is inserted between a side in each flank of the shutter and an opposing face of corresponding one of the support frames facing the side. The weatherstrip includes a long base material fixed to the support frame, a plurality of threads raised on the base material, and film member provided on the base material. The film member has a higher rigidity than the treads, and the height of the film member in a direction towards the opposing face of the support frame is lower than that of the treads. When the shutter is subjected to a strong external force, effective suppression of chattering of the shutter is achieved while at the same time reducing sliding resistance of the shutter.

### TECHNICAL FIELD

The present invention relates to a weatherstrip for a shutter device that is inserted between a shutter in the shutter device and a support frame that supports the shutter.

### BACKGROUND ART

In general, shutter devices have a pair of support frames constructed in parallel, and with a predetermined distance therebetween. On opposing sides of both support frames that face each other, guide grooves are respectively provided so as to extend along a vertical direction. With both flanks of shutters being inserted into respective guide grooves, a shutter is configured in such a way that a direction of movement of the shutter when it goes up and down will be a vertical direction along a longitudinal direction of the support frames. On an inner side facing one of both shutter flanks in the guide groove is provided a weatherstrip not only for moving the shutter up and down smoothly but also for alleviating impact noise that accompanies vibration of the shutter when a strong wind is blowing.

Conventionally proposed as such a weatherstrip has been a belt-like base material having raised pile threads (pile) that is attached to the inner side of the guide grooves (e.g., Patent Document 1). To reduce sliding resistance when the shutter goes up and down, and to enhance a buffering effect in relation to the shutter, the weatherstrip of Patent Document 1 not only uses relatively thick pile threads but also forms curly parts by curling the pile threads.

Since the weatherstrip of Patent Document 1 uses relatively thick pile threads that have been curled, a problem arises that while it is possible to suppress chattering of the shutter when it is subjected to a wind slightly stronger than a normal wind, it is difficult to suppress chattering when the shutter is subjected to a very strong wind such as typhoon.

Further, a weatherstrip having fins is disclosed in Patent Document 1 to 6, the entire contents of which are hereby incorporated by reference.

### Patent Document 1: Japanese Laid-Open Patent Publication No. 2004-116140

Patent Document 2: U.S. Pat. No. 4,148,953
Patent Document 3: U.S. Pat. No. 4,302,494
Patent Document 4: U.S. Pat. No. 5,338,382
Patent Document 5: U.S. Pat. No. 5,807,451
Patent Document 6: U.S. Pat. No. 5,817,390

### DISCLOSURE OF THE INVENTION

The present invention was made in light of such a problem in the conventional art. It is therefore an objective of the invention to provide a weatherstrip for a shutter device that can effectively suppress chattering of a shutter when the shutter is subjected to a strong external force, while at the same time reducing sliding resistance of the shutter.

To achieve the above objective, the present invention provides the following weatherstrip for a shutter device. The shutter device includes a pair of support frames arranged in parallel, and with a predetermined distance therebetween, and a shutter installed between the support frames. The support frames support both flanks of the shutter to allow the shutter to reciprocate along a longitudinal direction of the support frames. The weatherstrip is inserted between a side of each flank of the shutter and an opposing side of corresponding one of the support frames facing that side, and includes a base material attached to the opposing side of the support frame, pile raised on the base material, and a buffer provided on the base material. The buffer has a higher degree of rigidity than the pile, and a height of the buffer in a direction towards the opposing side of the support frame is lower than that of the pile.

According to the above configuration, if the shutter chatters weakly while it is reciprocating, sliding resistance of the shutter is alleviated because each thread of the pile buffers chattering of the shutter while contact between the shutter and the buffer is suppressed. On the one hand, if the shutter badly chatters when it is subjected to a very strong external force (e.g., a very strong wind at a time of a typhoon, etc.), the chattering of the shutter is effectively suppressed because the chattering of the shutter is cushioned by the buffer, and not by each thread of the pile. Thus, when the shutter is subjected to a strong external force, it becomes possible to suppress chattering of the shutter effectively while at the same time alleviating sliding resistance of the shutter.

The base material is preferably formed like a belt that runs along a longitudinal direction of the support frame. In addition, the buffer is preferably made of a belt-like film member provided in such a way that a longitudinal direction thereof extends along a longitudinal direction of the base material, and a transverse direction thereof is an upward direction from the base material. In this case, since the buffer is made of the belt-shaped film member, it becomes possible to manufacture weatherstrips easily.

The buffer preferably forms a series of bent or curved waves repeated along a longitudinal direction of the base material. In these circumstances, improved strength of the buffer is achieved in the direction in which it is subjected to shock that accompanies chattering of the shutter.

The buffer is preferably positioned together with the pile in the raised area of the pile on the base material. In this case, it becomes possible to position a buffer on a base material while at the same time saving space.

It is also preferable that the buffer be positioned on the base material so as to support the pile laterally. For instance, if a sliding surface of the shutter is irregular, there is risk that threads of pile might be caught on the irregular surface and might thus be torn apart. In this respect, with the above configuration, as the buffer restrains the pile from being flattened when the shutter slides against the pile, the pile is less susceptible to being caught on the irregular sliding surface of the shutter, thereby reducing the risk of the pile being torn apart by the shutter.

Another aspect of the present invention provides a weatherstrip for a shutter device that is constructed as follows. The shutter device includes a pair of parallel support frames and a shutter. The support frames are spaced from each other at a predetermined distance. The shutter is arranged between the support frames. The support frames support opposing sides of the shutter in such a manner as to allow reciprocation of the shutter in the longitudinal direction of the support frames. The weatherstrip is provided between the surface of each of the opposing sides of the shutter and the opposing surface of the corresponding support frame. The weatherstrip includes a base material secured to the opposing surface of the corresponding support frame and a plurality of pile threads projecting from the base material. The base material has a buffer having rigidity higher than that of each of the pile threads. The height of the buffer in a direction toward the opposing surface of the corresponding support frame is smaller than that of each pile thread.

If the extent of chattering of the shutter caused by reciprocation of the shutter is relatively small, the pile threads flexibly absorb the chattering of the shutter while suppressing contact between the shutter and the buffer. This decreases sliding resistance of the shutter. Contrastingly, if the shutter receives intense external force (as in the case of a typhoon involving intense winds) and causes excessive chattering, the buffer, not the pile threads, absorbs the chattering of the shutter and thus effectively suppresses such chattering. That is, the excessive chattering of the shutter caused by the intense external force is effectively suppressed while decreasing the sliding resistance of the shutter.

### BRIEF DESCRIPTION OF THE DRAWINGS

FIG. 1 is a partly cutaway front view of a shutter device according to one embodiment of the present invention.

FIG. 2 is a top cross-sectional view showing an essential part of the shutter device of FIG. 1.

FIG. 3 is a side cross-sectional view showing an essential part of the shutter device of FIG. 1.

FIG. 4 is a perspective view of a weatherstrip with which the shutter device of FIG. 1 is provided.

FIG. 5 is a cross-sectional view taken along line 5-5 of FIG. 4.

FIG. 6 is a perspective view showing a condition in which the film member is being coined.

FIG. 7 is an enlarged cross-sectional view of FIG. 6.

FIG. 8 is an enlarged cross-sectional view of the film member after being coined.

FIG. 9 is a cross-sectional view for illustrating action of the weatherstrip of FIG. 4.

FIG. 10 is a cross-sectional view for illustrating action of the weatherstrip of FIG. 4.

FIG. 11 is a cross-sectional view of a weatherstrip of a modification of the present invention.

FIG. 12 is a cross-sectional view of a weatherstrip of another modification of the present invention.

FIG. 13 is a cross-sectional view of a weatherstrip of a further modification of the present invention.

FIG. 14 is a cross-sectional view of a weatherstrip of a further modification of the present invention.

FIG. 15 is a cross-sectional view of a weatherstrip of a further modification of the present invention.

FIGS. 16(a) and 16(b) are top views of a weatherstrip of a further modification of the present invention.

FIG. 17 is a cross-sectional view showing a weatherstrip of another modification of the present invention.

FIG. 18 is a cross-sectional view showing a weatherstrip of another modification of the present invention.

FIG. 19 is a cross-sectional view showing a weatherstrip of another modification of the present invention.

FIG. 20 is a cross-sectional view showing a weatherstrip of another modification of the present invention.

FIG. 21 is a cross-sectional view showing a weatherstrip of another modification of the present invention.

FIG. 22 is a cross-sectional view showing a weatherstrip of another modification of the present invention.

FIG. 23 is a cross-sectional view showing a weatherstrip of another modification of the present invention.

FIG. 24(a) is a cross-sectional view showing a weatherstrip of another modification of the present invention.

FIG. 24(b) is a side view showing a pile body of the weatherstrip of FIG. 24(a).

FIG. 25 is a cross-sectional view for illustrating a compressive resistance performance test of a weatherstrip of Example 1.

FIG. 26 is a cross-sectional view of a weatherstrip of Comparative Example 1.

FIG. 27(a) is a graph showing a relationship between pressure and compression margin in a compressive resistance performance test of the weatherstrip in Example 1.

FIG. 27(b) is a graph showing a relationship between pressure and compression margin in the compressive resistance performance test of the weatherstrip in Comparative Example 1.

### BEST MODE FOR CARRYING OUT THE INVENTION

One embodiment of the present invention will now be described with reference to the drawings.

First, a configuration of a shutter device 10 that uses a weatherstrip 20 of the present embodiment will be described.

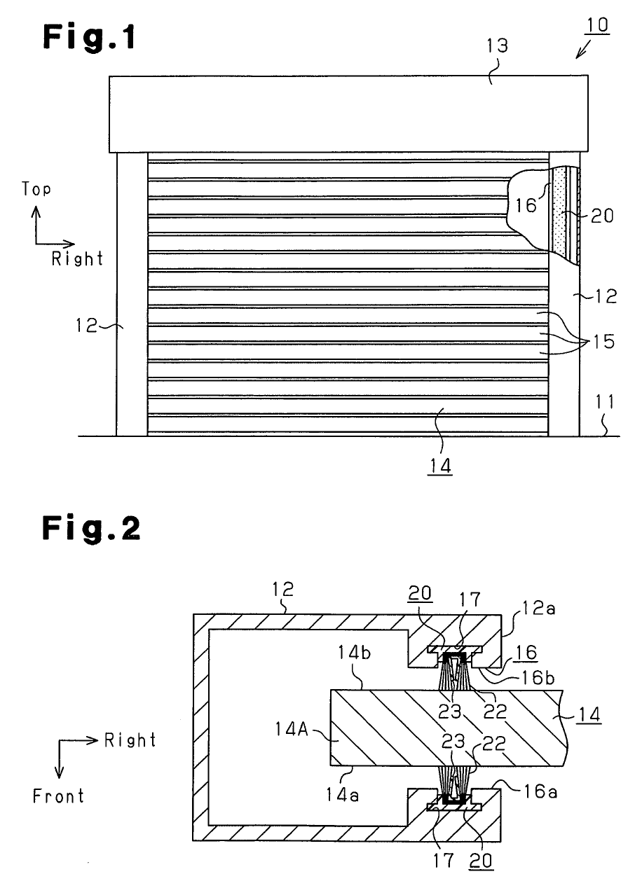

As shown in FIG. 1, the shutter device 10 includes a pair of support frames 12 constructed in parallel on a floor 11 with a predetermined distance therebetween, a housing 13 installed between upper ends of the two support frames 12, and a shutter 14 arranged in a space surrounded by the housing 13, the floor 11 and both support frames 12. The shutter 14 is comprised of a plurality of blades 15 running in a horizontal direction and is configured in such a way that the blades 15 adjacent to each other in a vertical direction are pivotally connected so that they can take both a spirally rolled form, and an unfolded form as shown in FIG. 1.

The housing 13 is formed like a rectangular box that not only has an underside opening, but also has a cylindrical drum (not shown) rotatably contained and supported therein. The top end of the shutter 14 is connected to the outer circumference of this drum. When the drum is rotated in a forward direction within the housing 13 to take the shutter 14 up onto the circumferential surface of the drum, the shutter device 10 will be in an open state in which the shutter 14 is accommodated in the housing 13. When the above-mentioned drum is rotated in a reverse direction to unwind the shutter 14 from the circumferential surface of the drum and pull it down while the shutter device 10 is in its open state, it will then be in a closed state in which the shutter 14 is unfolded between the housing 13 and the floor 11.

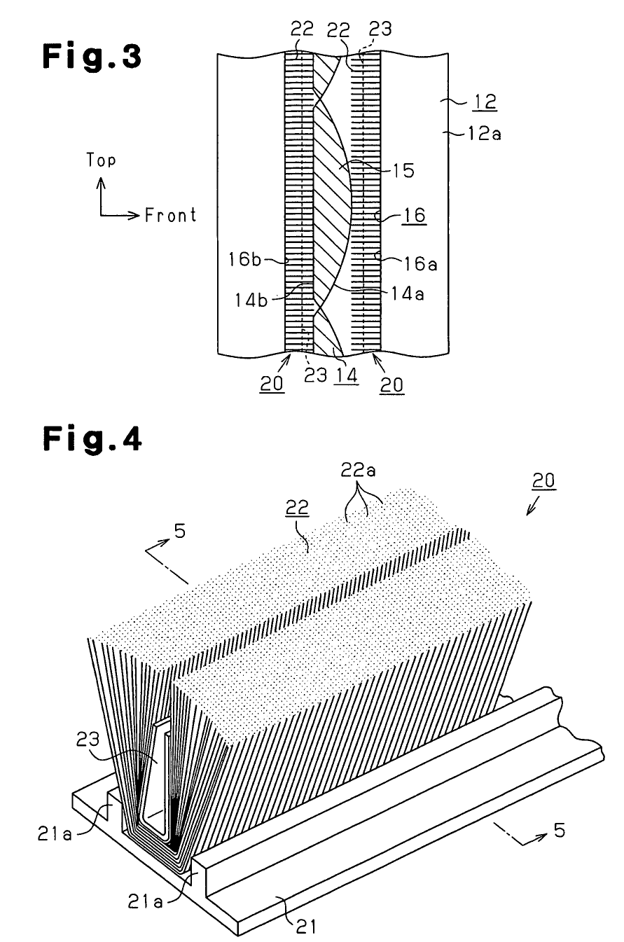

As shown in FIG. 2 and FIG. 3, on mutually facing inner sides 12a of a pair of the support frames 12 that have been made of metal and formed like a rectangular column are made guide grooves 16 that extend along a longitudinal direction of the support frames 12. Both right and the left flanks 14A of the shutter 14 are respectively inserted into the guide grooves 16 of the two support frames 12. When an opening or closing operation is performed to put the shutter device 10 in an open or a closed state, the shutter 14 is supported to reciprocate vertically with its horizontal and back-and-forth movement restrained by the guide grooves 16 of the two support frames 12.

On respective inner front and rear faces (opposing sides) 16a, 16b of the guide grooves 16 that respectively face the front face (side) 14a and the rear face (side) 14b of the shutter 14 in a cross direction are respectively defined dovetail groove-like accommodation grooves 17. The accommodation grooves 17 open onto the front face 14a and the rear face 14b of the shutter 14 so as to extend along a longitudinal direction of the support frame 12. With both flanks 14A of the shutter 14 inserted into the guide grooves 16, clearances are respectively made between the respective inner front and rear faces 16a, 16b of the guide grooves 16 and the front face 14a and the rear face 14b of the shutter 14. Weatherstrips 20, to be described later, are inserted between the front face 14a and the rear face 14b of both flanks 14A in the shutter 14, and the respective inner front and rear faces 16a, 16b of the guide grooves 16 in the support frame 12.

Next, a configuration of the weatherstrips 20 will be described.

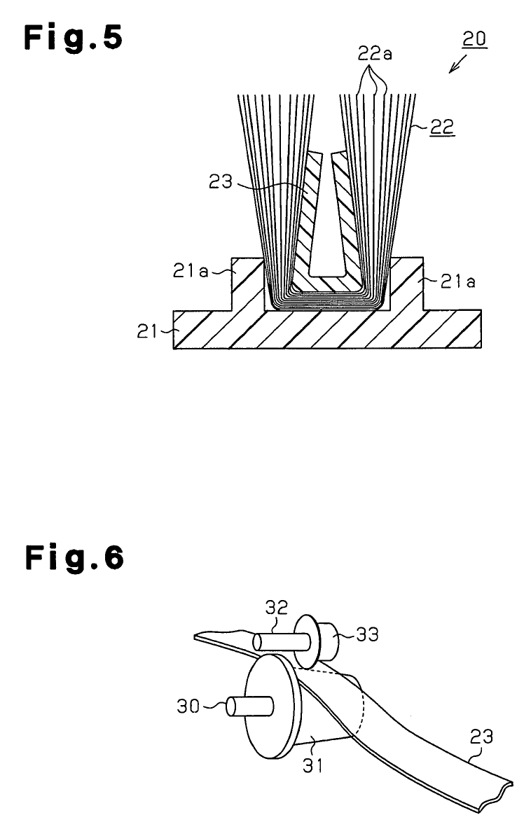

As shown in FIG. 4 and FIG. 5, each weatherstrip 20 includes a base material 21 that is comprised of polypropylene moldings and shaped like a long belt, a pile section 22 comprised of a multitude (plurality) of threads 22a raised on the base material 21, and a belt-shaped film member 23 as a buffer also to be raised on the base material 21 together with the threads 22a. On the base material 21, a pair of projections 21a are provided at positions spaced apart by a predetermined distance in a transverse direction of the base material 21, extending along a longitudinal direction of the base material 21, and a space between both projections 21a is intended as an area for the respective threads 22a that constitute the pile section 22 to be raised up.

Inside of the threads 22a that are formed into bundles and folded down so that their section is almost like a letter U, the weatherstrip 20 is formed by arranging, the film member 23 that is also folded down so that its section is likewise almost like a letter U, and by welding by ultrasonic waves (thermally welding) the film member 23 on the base material 21 together with the bundle of threads 22a that constitute the pile section 22. Both the projections 21a on the base material 21 are designed to act as a positioning means in welding by ultrasonic waves, the threads 22a and the film member 23 on the base material 21. In this weatherstrip 20, the film member 23 is set to have a higher degree of rigidity than that of the pile section 22 that is made up of a collection of threads 22a, and a height of the film member 23 in an upward direction from the base material 21 is set lower than that of the threads 22a of the pile section 22.

As shown in FIG. 2 and FIG. 3, with the base materials 21 of the weatherstrips 20 respectively inserted and fixed in the two accommodation grooves 17 of the shutter device 10, the pile section 22 (the respective threads 22a) and the film member 23 are made to protrude farther toward the front face 14a and the rear face 14b of the shutter 14 than do the respective inner front and rear faces 16a, 16b of the guide groove 16. In these circumstances, ends of the pile section 22 of both weatherstrips 20 lightly touch the front face 14a and the rear face 14b of the shutter 14, respectively, and ends of the film member 23 are respectively spaced relative to the front face 14a and the rear face 14b of the shutter 14.

As shown in FIG. 4 and FIG. 5, it is preferable to use polypropylene fibers having a fineness of 10 to 30 decitex for the respective threads 22a constituting the pile section 22 of the weatherstrip 20. In the present embodiment, polypropylene fibers having a fineness of 20 decitex are used for the respective threads 22a. If the fibers constituting the respective threads 22a are thinner than 10 decitex, it is impossible to cushion adequately chattering of the shutter when the shutter 14 reciprocates along the guide grooves 16 of the two support frames 12. On the other hand, if the fibers constituting the respective threads 22a are thicker than 30 decitex, sliding resistance of the shutter 14 will intensify when the shutter reciprocates along the guide grooves 16 of the two support frames 12 and there is a danger that the opening and closing operations of the shutter 14 being adversely affected.

Used as the film member 23 of the weatherstrips 20, is a film member of a polypropylene non-woven fabric one side of which has been coated and reinforced (preferably, a commercial product named Typar of E.I. du Pont de Nemours and Company having a coating weight of 100 to 400 g/m² is used). The film member 23 preferably has a thickness of 0.1 to 0.5 mm. If the film member 23 is less than 0.1 mm thick, impact when the shutter 14 chatters substantially cannot be sufficiently cushioned. On the one hand, if the film member 23 is thicker than 0.5 mm, its workability will diminish considerably. If the coating weight of the non-woven fabric constituting the film member 23 is less than 100 g/m², strength of the film member 23 will be inadequate, and if it is greater than 400 g/m², processing of the film member 23 will be difficult.

The film member 23 should be folded so that its cross section is precisely shaped like a letter U, so as to improve precision in the height of the film member 23 in the base material 21. Next, a method of folding back the film member 23 will be described.

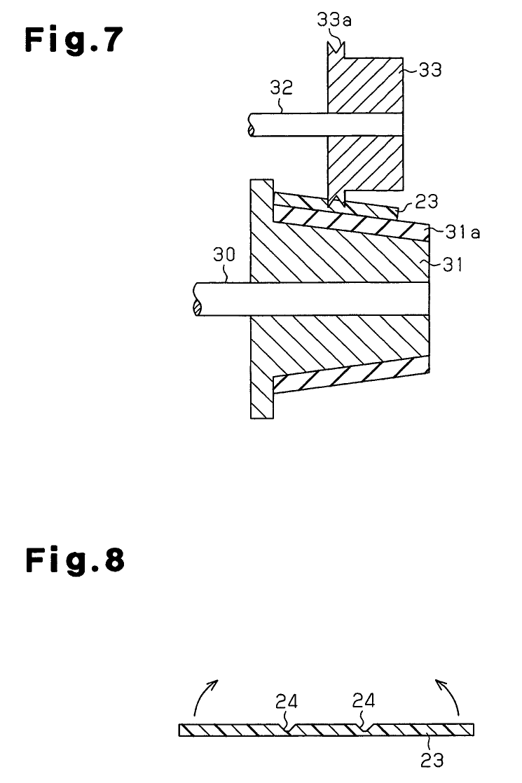

To fold down the film member 23 precisely, first, it is necessary to crease the film member 23 accurately. To this end, as shown in FIG. 6 and FIG. 7, the film member 23 should be creased by coining a process in which are used a major roller 31 that rotates around a first shaft 30 and a minor roller 33 that rotates around a second shaft 32, and is parallel to the first shaft 30. In other words, a circumferential surface of the major roller 31 is covered by a sleeve 31a made of elastomer, and pressing blades 33a whose cross section is V-shaped are provided in a position on a circumferential surface of the minor roller 33 that axially corresponds to the circumferential surface of the major roller 31.

Then, when the major roller 31 is revolved with the film member 23 placed on the circumferential surface (sleeve 31a) of the major roller 31 and sandwiched between the circumferential surface and the pressing blades 33a of the minor roller 33, the minor roller 33 also rotates accordingly with this revolution. As shown in FIG. 8, if this is done, a pair of depressions 24 are formed by the pressing blades 33a at the center of the transverse direction of the film member 23 on one flank of the film member 23, so that they extend along a longitudinal direction of the film member 23. Then, the film member 23 is folded down in the pair of depressions 24, and the film member 23 is folded down precisely in such a way that its cross section is shaped almost like a letter U. This method of folding film member 23 by coining is described in the specification of U.S. Pat. No. 5,338,382, including a method of manufacturing weatherstrips 20. The entire contents of U.S. Pat. No. 5,338,382 are hereby incorporated by reference.

Next, operations of the weatherstrips 20 will be described.

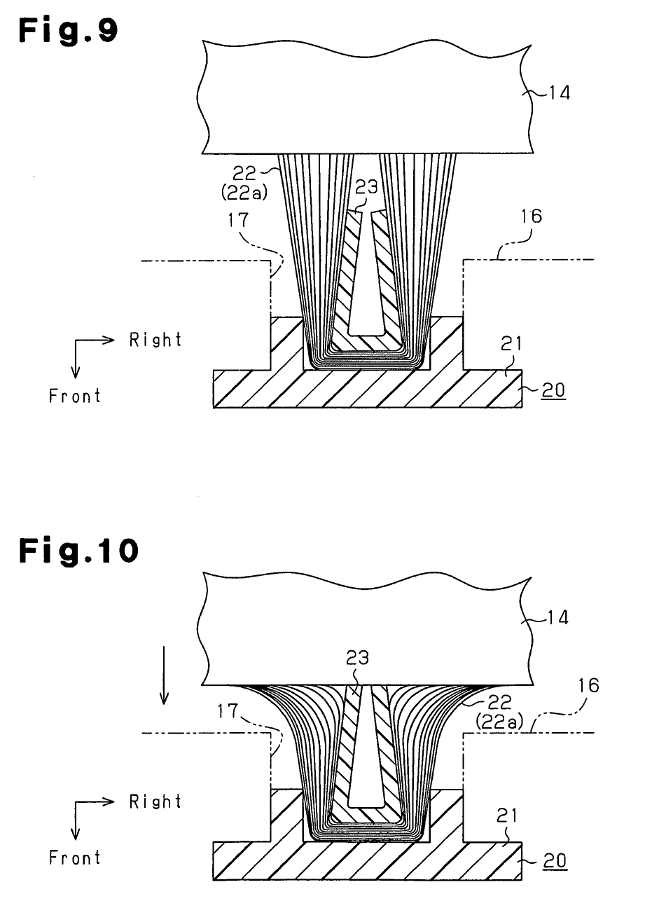

As shown in FIG. 9, if the shutter 14 chatters lightly in a cross direction when it reciprocates for opening or closing, the shutter 14 does not touch the film member 23 and the pile section 22 softly cushions the chattering of the shutter 14. Thus, in this case, not only is the sliding resistance of the shutter 14 is lowered, but also the level of noise caused by sliding of the shutter 14 is reduced. Even if the shutter 14 chatters horizontally when subjected to a weak wind while the shutter device 10 is closed, the shutter does not make contact with the film member 23, and the pile section 22 softly cushions the chattering of the shutter, thereby reducing the level of possible impact noise caused by the chattering of the shutter 14.

On the one hand, as shown in FIG. 10, while the shutter device 10 is in closed state, if the shutter 14 chatters badly in a cross direction when subjected to a very strong wind caused by a typhoon, etc., the shutter 14 is received by a film member 23 that has a high degree of rigidity and although the pile section 22 may be crushed by the shutter 14, the chattering is thereby cushioned. Therefore, in such circumstances, not only can chattering of the shutter 14 be suppressed effectively, but also the degree of impact noise caused by chattering of the shutter 14 is reduced effectively.

According to the embodiment elaborately described in the above, the following effects are achieved.

(1) The weatherstrips 20 have the film member 23 provided on the base material 21, the film member 23 being lower than the height of the threads 22a of the pile section 22 and having higher degree of rigidity than the pile section 22. Thus, if the shutter 14 lightly chatters when the shutter 14 reciprocates, the sliding resistance of the shutter 14 is reduced because the shutter 14 does not come into contact with the film member 23, and the threads 22a of the pile section 22 softly cushion the chattering of the shutter 14. On the one hand, if the shutter 14 chatters badly when subjected to a very strong wind such as a typhoon, although the threads 22a of the pile section 22 cannot cushion the chattering of the shutter 14, the chattering of the shutter 14 is still effectively suppressed because it is cushioned by the film member 23,

(2) Since the buffer consists of the belt-shaped film member 23 provided to extend along a longitudinal direction of the base material 21, it becomes possible to manufacture weatherstrips 20 easily.

(3) Since the film member 23 is arranged together with the threads 22a within an area on the base material 21 where the threads 22a are raised, the film member 23 is arranged in a compact space on the base material 21 without being bulky.

The above embodiment may be modified in the following manners.

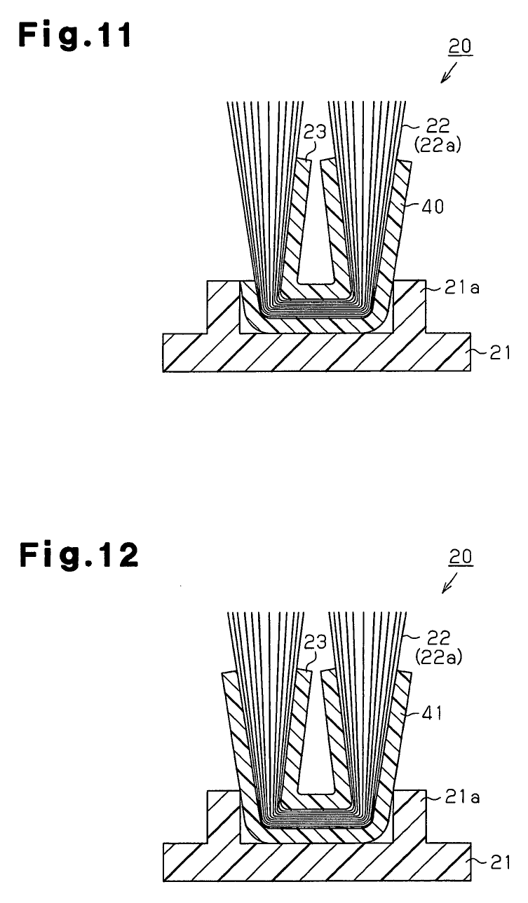

As shown in FIG. 11, in the weatherstrip 20 of FIG. 5, an additional film member 40 may be provided on the base material 21 so that the threads 22a of the pile section 22 are supported from one of the two sides in a transverse direction of the base material 21. In this case, as the threads 22a of the pile section 22 are nipped and held by the two film members 23, 40, when the shutter slides against the threads 22 of the pile section 22, the threads 22a are rendered less susceptible of being caught in the unevenness of the revolving section among the respective blades 15 of the shutter 14. In other words, as both films suppress the threads 22a from being flattened when the shutter 14 slides against the threads 22a of the pile section 22, it is possible to reduce the risk of the threads 22a being caught in the unevenness of the revolving section among the blades 15 of the shutter and thus of the threads 22a being torn apart.

As shown in FIG. 12, in the weatherstrips 20 of FIG. 5, an additional film member 41 may be provided on the base material 21 so that the threads 22a of the pile section 22 are supported from both sides in a transverse direction of the base material 21. In this case, as the threads 22a of the pile section 22 are more strongly nipped and held by the two film members 23, 41, when the shutter 14 slides against the threads of the pile section 22, the threads 22 are rendered less unsusceptible of being caught in the unevenness of the revolving section among the blades 15 of the shutter 14. In other words, as both films 23, 41 suppress more effectively the threads 22a from being flattened when the shutter 14 slides against the threads 22a of the pile section 22, it is possible to further reduce the risk of the threads 22a being caught in the unevenness of the revolving section among the respective blades 15 of the shutter, and thus of the threads 22a being torn apart.

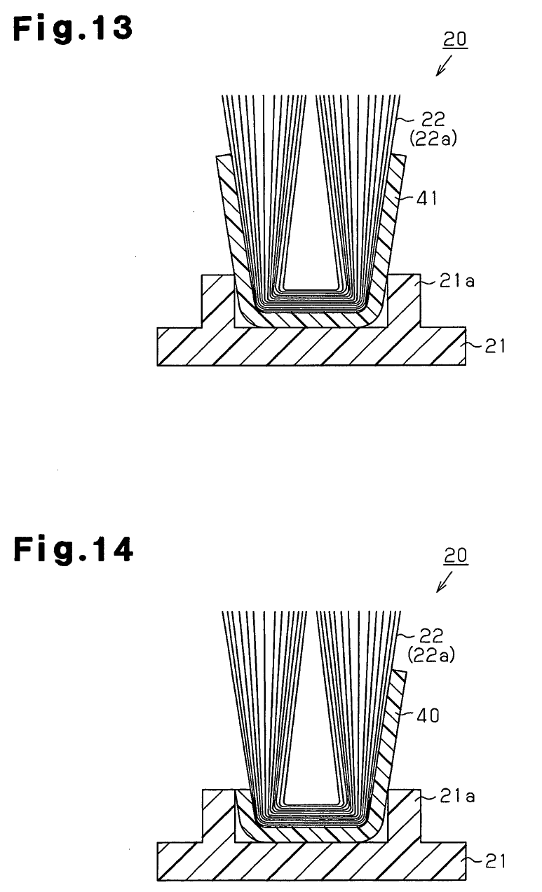

As shown in FIG. 13, in the weatherstrip 20 of FIG. 5, not only may the film member 23 be omitted but also a film member 41 may be provided on the base material 21 so that the threads 22a of the pile section 22 are supported by both sides in a transverse direction of the base material 21.

As shown in FIG. 14, in the weatherstrip 20 of FIG. 5, not only may the film member 23 be omitted but also a film member 40 may be provided on the base material 21 so as to support the threads 22a of the pile section 22 from one of the two sides in a transverse direction of the base material 21.

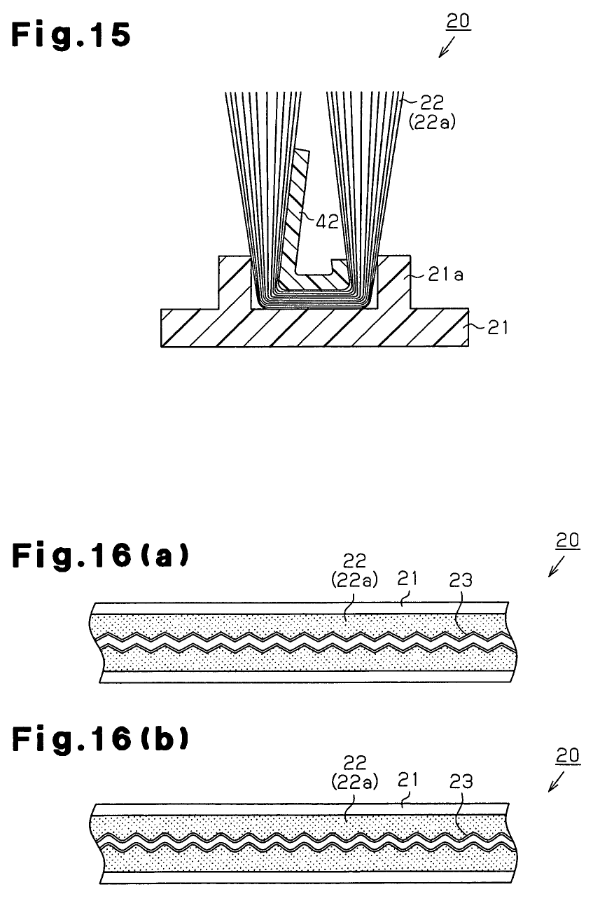

As shown in FIG. 15, in the weatherstrip 20 of FIG. 5, a film member 42 whose cross section is substantially like a letter L may replace the film member 23.

As shown in FIG. 16 (a), in the weatherstrip 20 of FIG. 5, arrangement and configuration of the film member 23 may be, as viewed from the top, a repetition of crooked corrugations along a longitudinal direction of the base material. In this case, it is possible to enhance the strength of the film member 23 in the direction in which an impact that accompanies chattering of the shutter 14 is received.

As shown in FIG. 16 (b), in the weatherstrip 20 of FIG. 5, arrangement and configuration of the film member 23 may be, as viewed from the top, a repetition of curved corrugations along a longitudinal direction of the base material. In this case, it is possible to enhance the strength of the film member 23 in the direction in which an impact that accompanies chattering of the shutter 14 is received.

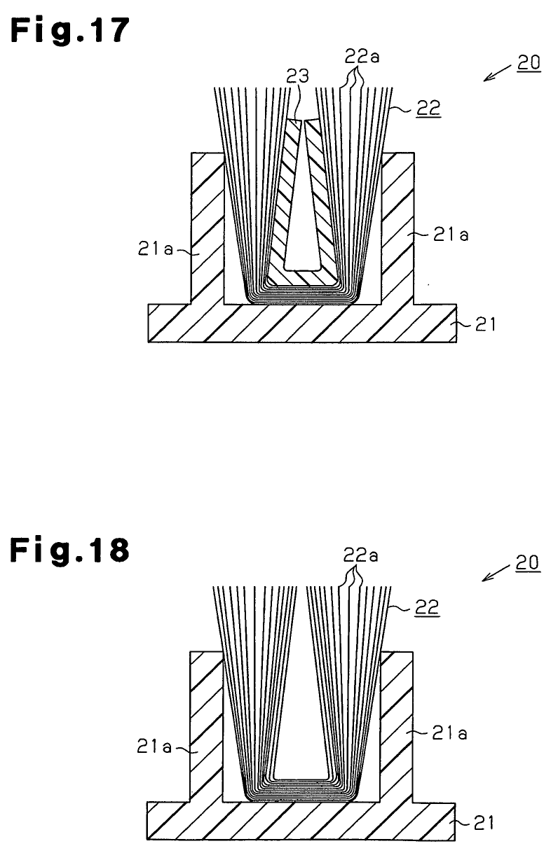

As shown in FIG. 17, the height of each projection 21a of the weatherstrip 20 of FIG. 5 may be increased in such a manner that the projections 21a function as buffers for absorbing chattering of the shutter 14. In this case, the height of each projection 21a from the base material 21 must be smaller than the height of the film member 23. Further, the rigidity of each projection 21a is higher than that of the film member 23. Accordingly, impact caused by the chattering of the shutter 14 is absorbed by the film member 23 and the projections 21a in a two-stepped manner in correspondence with the extent of the chattering of the shutter.

As shown in FIG. 18, the film member 23 may be omitted from the weatherstrip 20 of FIG. 17. Since the projections 21a (the base material 21), each of which functions as the buffer that absorbs chattering of the shutter 14, is a molded product of synthetic resin (polypropylene), the projections 21a are easily installed on the base material 21 compared to the film member 23. Further, the material of the projections 21a may be selected from a wider range compared to the film member 23. Therefore, the rigidity of each projection 21a (the buffer) can be easily adjusted by changing the material of the projections 21a in correspondence with different conditions.

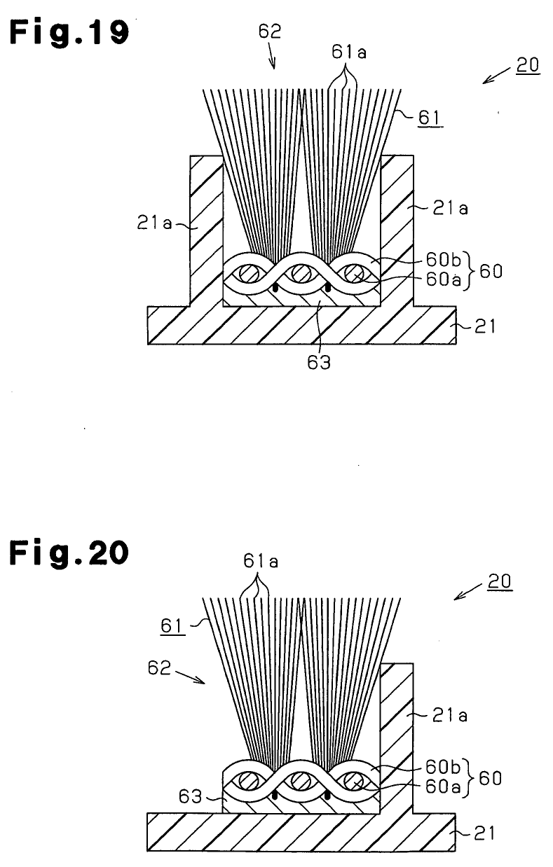

As shown in FIG. 19, the pile section 22 of the weatherstrip 20 of FIG. 18 may be replaced by a pile member 62. The pile member 62 includes an elongated base fabric 60 and a pile section 61. The pile section 61 is formed by a group of pile threads 61a projecting from the base fabric 60 and aligned in the longitudinal direction of the base fabric 60. In this case, the height of each projection 21a from the base material 21 must be smaller than the height of the pile section 61 of the pile member 62. The pile member 62 is provided using woven fabric formed of warp yarn 60a and weft yarn 60b both formed of synthetic fiber. The pile section 61 is formed by pile weaving the pile threads 61a into the base fabric 60. Specifically, in the pile weaving, each of the pile threads 61a, which define the pile section 61, is woven into the base fabric 60 while being intertwined with the weft yarn 60b. A coating layer 63 formed of synthetic resin coating material is formed on a surface of the base fabric 60 opposed to the side at which the pile section 61 is provided. The bases of the pile threads 61a (the base of the pile section 61) and the base fabric 60 are bonded together by the coating layer 63. The pile member 62 is fixedly adhered to the base material 21 at a position between the projections 21a. Alternatively, the pile member 62 may be fixed to the base material 21 through thermal welding, not adhesion. In this case, the bases of the pile threads 61a (the base of the pile section 61) and the base fabric 60 are bonded together through the thermal welding. The coating layer 63 must thus be omitted.

As illustrated in FIG. 20, one of the projections 21a may be omitted from the weatherstrip 20 of FIG. 19.

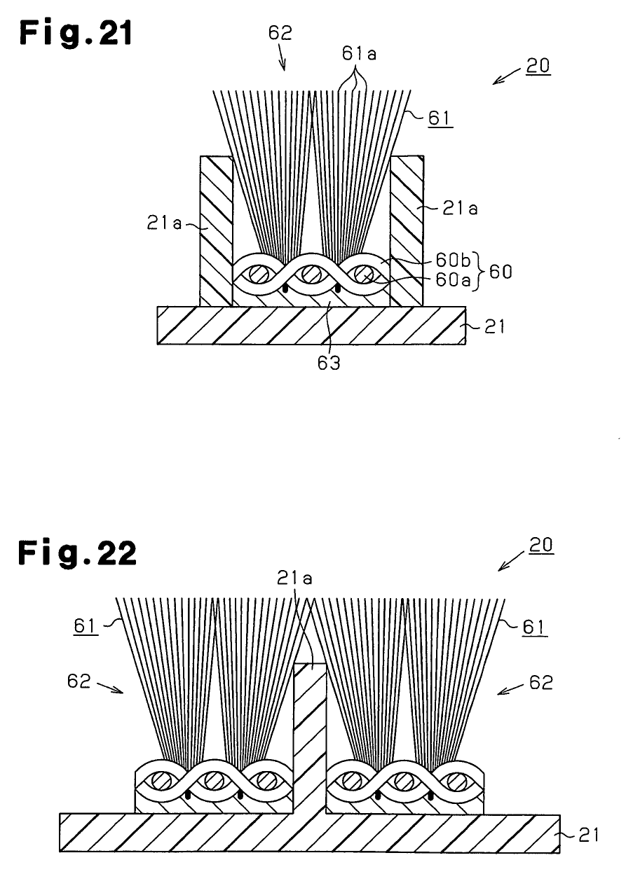

Referring to FIG. 21, the projections 21a of the weatherstrip 20 of FIG. 19 may have rigidity lower than the rigidity of the base material 21 but higher than the rigidity of each pile thread 61a (the pile section 61). Specifically, the projections 21a are formed integrally with the base material 21 through extrusion molding, while using soft resin for the material of the projections 21a and hard resin for the material of the base material 21. Alternatively, the projections 21a may be formed independently from the base material 21 and then adhered or thermally welded to the base material 21.

As shown in FIG. 22, a single projection 21a may project from the base material 21 of the weatherstrip 20 of FIG. 5 at the lateral center of the base material 21. Pile members 62 are arranged on the base material 21 (through adhesion or thermal welding) at opposing sides of the projection 21a and adjacently to the projection 21a. In this case, the height of each projection 21a from the base material 21 must be smaller than the height of the pile section 61 of the pile member 62. If the pile members 62 are fixed to the base material 21 through thermal welding, the coating layer 63 must be omitted for the same reason as that of the case of the weatherstrip 20 of FIG. 19.

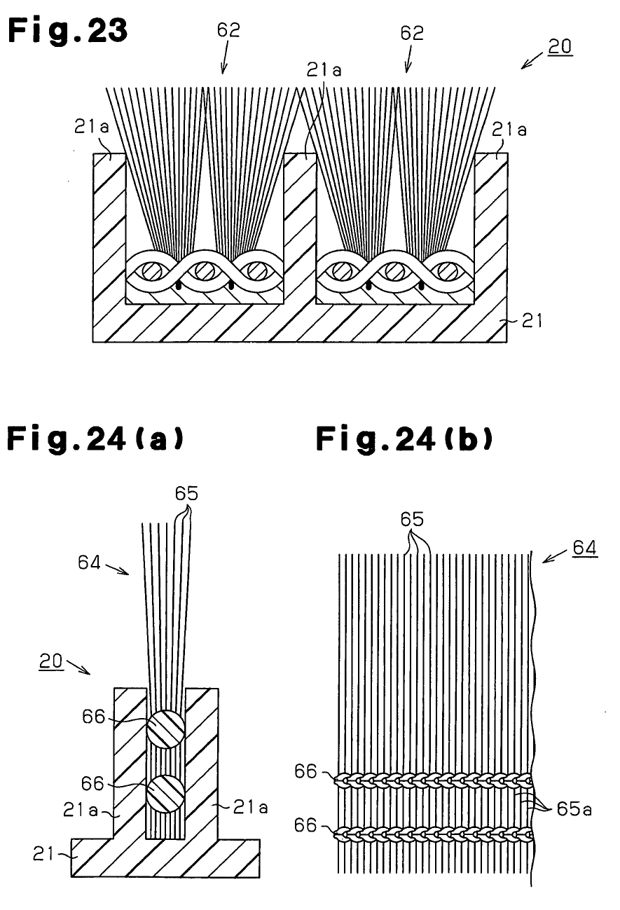

As shown in FIG. 23, additional projections 21a may be provided on the base material 21 of the weatherstrip 20 of FIG. 22 at opposing lateral sides of the base material 21. In other words, three projections 21a and two pile members 62 are provided on the base material 21 in such a manner that the projections 21a alternate the pile members 62.

As shown in FIG. 24(a), the height of each projection 21a of the weatherstrip 20 of FIG. 5 may be increased in such a manner that the projection 21a functions as a buffer that absorbs chattering of the shutter 14. In this case, the pile section 22 and the film member 23 are replaced by an elongated pile body 64 having a smaller lateral dimension than that of the pile section 22. More specifically, referring to FIG. 24(b), the pile body 64 includes a plurality of pile threads 65 that have uniform lengths and are arranged in parallel in one direction. A base 65a of each of the pile threads 65 corresponds to a base portion of the pile body 64. The bases 65a of the pile threads 65 are sewn together by two sewing threads 66, each of which extends in a direction perpendicular to the pile threads 65 (in the longitudinal direction of the pile body 64). Each of the sewing threads 66 is formed by a thermal adhesion melting thread (a thermoplastic resin thread). Therefore, by thermally welding the sewing threads 66, the pile threads 65 are connected together as one body to define the elongated pile body 64. The pile body 64 of the weatherstrip 20 is fixed to the base material 21 by adhering or thermally welding the base of the pile body 64 (the bases of the pile threads 65) to the base material 21. The distance between the projections 21a is reduced in correspondence with the lateral dimension of the pile body 64. In this case, the height of each projection 21a from the base material 21 must be smaller than the height of the pile body 64. This decreases the width of the weatherstrip 20 as a finished product, thus saving the space for accommodating the weatherstrip 20.

Referring to FIG. 8, formation of creases (depressions 24) on the film member 23 may be formed through extrusion molding in advance, rather than being formed on a manufacturing line. In other words, the film member 23 may be formed by an extrusion molding, and a protrusion for forming depressions 24 may be provided on a die to be used when extruding the film member 23.

The method of making creases (depressions 24) on the film member 23 need not be limited to coining as long as a process is used that can make creases (depressions 24) on the film member 23 by causing plastic deformation through application of pressure.

The material of the weatherstrip 20 is not limited to polypropylene. For instance, the material of the entire weatherstrip 20 may be polyamide. In this case, it is possible to provide a weatherstrip 20 with an even higher level of durability and shock-absorbing properties, thanks to the excellent resilience and abrasion resistance at the part of polyamide fibers.

In the weatherstrip 20, the film member 23 may be provided on the base material 21, intermittently extending along a longitudinal direction of the base material 21.

Alternatively, the shutter device 10 may be of type that causes the shutter to simply move up and down when it is opened or closed, rather than that of the present embodiment the type that rewinds or unwinds the shutter 14 when it is opened or closed.

Any values may be set to the heights of the film members 23, 40, 41, 42, provided that they are lower than that of the threads 22a of the pile section 22.

The weatherstrip 20 may also be made by welding by ultrasonic waves, the film member 23 on the base material 21, after joining the rear surface of the base material 21 and the roots of the threads 22, by forming a base material 21 of woven fabric that can be made by weaving warp yarns and weft yarns and by thermally welding a synthetic resin such as polypropylene, etc., on the rear side of the base material 21.

The film member 23 may be composed of a polypropylene extrusion molding to which flexibility has been added, by dispensing, for instance, rubber components.

Next, an example of the above illustrated embodiment and a comparative example will be described.

### EXAMPLE 1

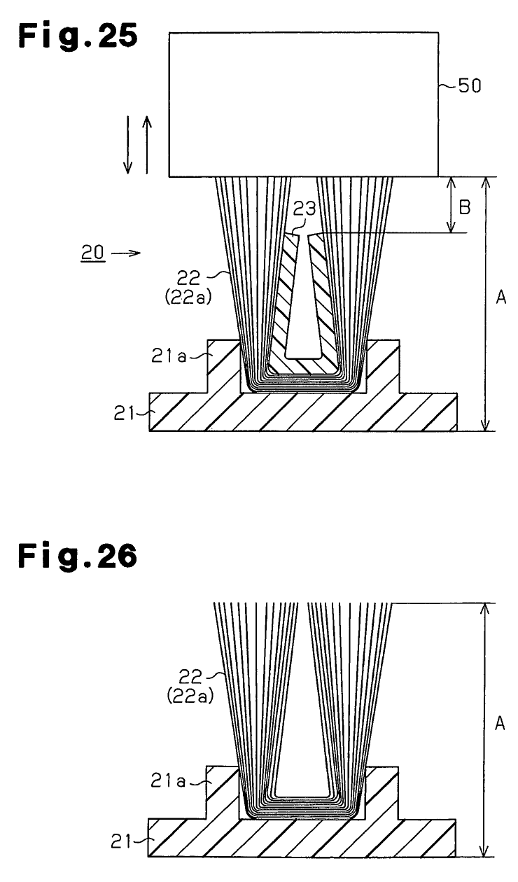

As shown in FIG. 25, Example 1 shall be such that a height A of the weatherstrip 20 in the embodiment is set to 6.0 mm, and a distance B extending from the end of the film member 23 to the end of the threads 22a of the pile section is set to 1.0 mm. The length of the weatherstrip 20 of Example 1 in a longitudinal direction is set to 250 mm.

### COMPARATIVE EXAMPLE 1

As shown in FIG. 26, a comparative example shall be one wherein only the film member 23 is omitted from the weatherstrip 20 of Example 1.

### Evaluation of Compressive Resistance Performance

As shown in FIG. 25, a compressive resistance performance test was conducted by using a compression device 50 for the above Example 1 and Comparative Example 1.

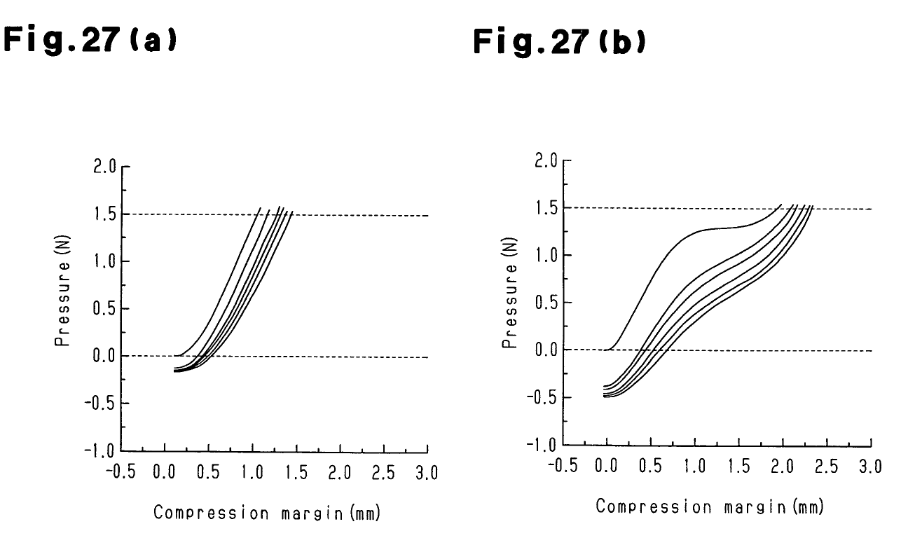

First, using the compression device 50, the weatherstrip 20 of Example 1 was repeatedly compressed from the side of the pile section 22 at a compression speed of 500 mm/second, until such time as pressure reached 1.5N. Then, measurements were taken of the compression margin (settled amount) when the number of instances of compression was respectively, 1, 2, 5, 10, 20, and 30 times. FIG. 27(a) shows the measurement results in the form of a graph. In addition, starting from the left, six curved lines on the graph show measurements of the occasions when the number of instances of compression was respectively 1, 2, 5, 10, 20 and 50 times.

Then, in a similar manner to that of Example 1, the compression margin (settled amount) of Comparative Example 1 was measured in respect of occasions when the number of instances of compression was respectively 1, 2, 5, 10, 20 and 50 times. FIG. 27(b) shows the results. In addition, starting from the left, six curved lines on the graph show measurements of occasions when the number of instances of compression was respectively 1, 2, 5, 10, 20 and 50 times.

According to the test results, the compression margin (settled amount) in Comparative Example 1 was greater than approximately 1.8 mm even when the number of instances of compression was only one time, in contrast, the compression margin (settled amount) in Example 1 was less than about 1.5 mm even when the number of instances of compression was 50 times.

### CONCLUSION

According to the above results, Example 1 results in a smaller compression margin (settled amount) than Comparative Example 1, even though the number of compressions in the case of the former was higher. Thus, it was clearly demonstrated that Example 1 has better compression resistance performance than Comparative Example 1.

1. A weatherstrip for a shutter device, the shutter device including a pair of support frames spaced in parallel with a predetermined distance therebetween, and a shutter arranged between the support frames, wherein the support frames support both flanks of the shutter so as to allow the shutter to reciprocate along a longitudinal direction of the support frames, and wherein the weatherstrip is inserted between a side of each flank of the shutter and an opposing side of corresponding one of the support frames facing the side of the flank, the weatherstrip characterized by:
a base material fixed to the opposing side of the support frame;
a plurality of threads raised on the base material; and
a buffer provided on the base material,
wherein the buffer has a higher degree of rigidity than the threads, and a height of the buffer in a direction towards the opposing side of the support frame is lower than that of the threads.

2. The weatherstrip according to claim 1, characterized in that the base material is shaped like a belt and extends along a longitudinal direction of the support frame, and the buffer is formed of a belt-shaped film member provided so that its longitudinal direction extends along a longitudinal direction of the base material, and its transverse direction is an upward direction from the base material.

3. The weatherstrip according to claim 2, characterized in that the buffer forms a series of crooked or curved corrugations repeated along a longitudinal direction of the base material.

4. The weatherstrip according to claim 1, characterized in that the buffer is arranged, together with the threads, in an area on the base material where the threads are raised.

5. The weatherstrip according to claim 1, characterized in that the buffer is arranged on the base material so as to support the threads laterally.

6. A weatherstrip for a shutter device, the shutter device including a pair of parallel support frames spaced from each other at a predetermined distance and a shutter arranged between the support frames, the support frames supporting opposing sides of the shutter in such a manner as to allow the shutter to reciprocate in a longitudinal direction of the support frames, the weatherstrip being provided between a surface of each of the opposing sides of the shutter and an opposing surface of the corresponding one of the support frames, the weatherstrip characterized by:
a base material secured to the opposing surface of the corresponding support frame; and
a plurality of pile threads projecting from the base material,
wherein the base material includes a buffer, and
wherein the buffer has rigidity higher than that of each of the pile threads, and the height of the buffer in a direction toward the opposing surface of the corresponding support frame is smaller than that of each pile thread.
